(19) United States
(12) Patent Application Publication
(10) Pub. No.: US 2021/0020075 A1
(43) Pub. Date: Jan. 21, 2021

(54) Secure grip sign holder

(71) Applicant: K-International, Inc., Waukegan, IL (US)

(72) Inventor: Ryan Masek, Volo, IL (US)

(73) Assignee: K-International, Inc., Waukegan, IL (US)

(21) Appl. No.: 16/515,359

(22) Filed: Jul. 18, 2019

(51) Int. Cl. G09F 7/18; G09F 7/04; G09F 7/12

(52) U.S. Cl. CPC G09F 7/18; G09F 7/04; G09F 2007/1847; G09F 2007/1852; G09F 2007/122; G09F 7/12

(57) ABSTRACT

A sign holder grips a sign by pressing gripper jaws against opposite sides of the sign at an edge region of the sign. The sign holder includes a fastener to exert a pressing force on the gripper jaws. A mounting portion on the sign holder mounts onto a front plate of a base. The base may include an under-shelf support configured to attach to an under-side of a shelf, either by a magnet or a clamp. The base may include a plurality of suction cups mounted on a suction cup adapter to which the sign holder may be affixed.

### BACKGROUND OF THE INVENTION

### Field of the Invention

The present invention relates generally to a sign holder and, more particularly, to a sign holder for gripping an edge region of a sign and supporting the sign on a structure.

### Description of the Related Art

Retail stores often are arranged to have aisles lined with shelves that hold products. A store may wish to call attention to a particular product in the aisle, for example to announce a new product or a new feature on the product, to announce a special price or promotion, or to increase customer awareness of the product. The store may use a sign that extends into the aisle—which may be referred to as an aisle intruder sign. Aisle intruder signs are readily seen by the customers, but may be bumped by customers passing by or by customers retrieving products from a lower shelf as well as by store staff who may be restocking selves.

One type of aisle intruder sign includes a sign of a stiff material such as a laminated paper or cardboard sign or a stiff plastic sheet sign that is held at the edge region of the sign so as to extend outward from a shelf. The sign is held in a gripper that grips the edge region of the sign. The gripper is mounted to extend the sign into the aisle. When mounted in this way the sign is readily seen while looking down the aisle.

### SUMMARY OF THE INVENTION

The present invention provides an apparatus for holding a sign. The sign holder includes a gripper that engages an edge region of the sign. The gripper includes gripping jaws that are configured to grasp the sign near the edge. The gripper is mounted on a base. The base is configured for attachment to a store shelf, cooler door, or other store fixture or structure to position the sign holder so that the sign extends into a position where it is visible in the store. The sign holder may also be used to mount a sign in a warehouse, public building, library, or other facility to a wall, post, shelf, fixture, cabinet, or other mounting location. Other mounting locations are also possible within the scope of this invention.

### BRIEF DESCRIPTION OF THE DRAWINGS

FIG. 1 is a front, top, right-side perspective view of a secure grip sign holder holding a sign and mounted on an under-shelf support that is attached to the under-side of a shelf;

FIG. 2 is a front, top, right-side perspective view of the secure grip sign holder holding a sign and mounted on a second embodiment of an under-shelf support that is attached to the under-side of a shelf;

FIG. 3 is a bottom, back, right-side perspective view of the secure grip sign holder;

FIG. 4 is an exploded view of the secure grip sign holder from a back, top, left-side perspective view;

FIG. 5 is an exploded view of the secure grip sign holder from a front, top, right-side perspective view;

FIG. 6 is a partially broken away view of the secure grip sign holder holding a sign;

FIG. 7 is a fragmentary view of the secure grip sign holder holding a sign and mounted on a support;

FIG. 8 is a top, right, front perspective view of the secure grip sign holder mounted on a glass panel using a suction cup adapter;

FIG. 9 is a top, right, front perspective view of the suction cup adapter;

FIG. 10 is a back, bottom, right perspective view of the suction cup adapter; and

FIG. 11 is a front elevational view of the suction cup adapter marked with an imaginary center line.

### DETAILED DESCRIPTION OF THE PREFERRED EMBODIMENTS

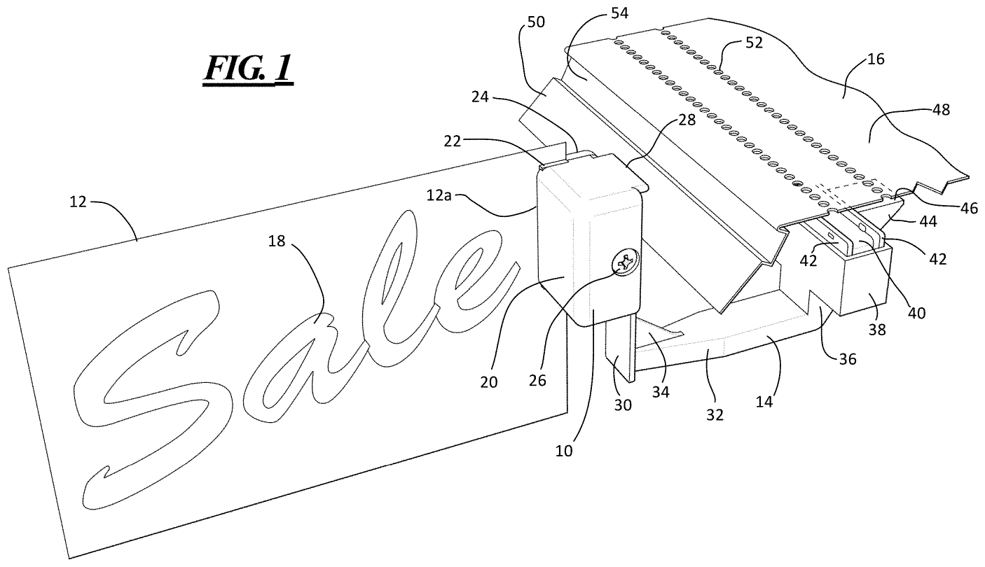

In FIG. 1, a secure grip sign holder 10 is shown holding a sign 12 in a position for viewing by a customer or other user. The sign holder 10 is mounted on an under-shelf support 14 that is connected to an underside of a shelf 16. The under-shelf support 14 may also be referred to as a base 14 The sign 12 is held extending outward from the front of the shelf 16. The sign 12 may extend outward from the shelf 16 such as into an aisle in a store, warehouse, or other facility so that the sign 12 is easily seen by a user when looking down the aisle. The sign 12 is held in a position that is perpendicular to the underside of the shelf 16 to which the base 14 is affixed. The sign 12 is also held perpendicular to the longitudinal direction of the shelf 16.

The sign 12 may be formed of a stiff durable material, such as of a stiff plastic sheet or laminated paper or cardboard sheet. The sign material may be opaque, translucent or transparent and may be of various shapes, sizes, colors, configurations. For example, the sign 12 may be rectangular, oval, shaped like the outline of a product such as a beverage bottle, or of some other shape. The sign may include eye-catching features such as holographic or iridescent features, lights, glitter, tinsel, and the like. The stiff, durable material of the sign 12 maintains the sign in a position extending outward from the sign holder 10 when gripped near the edge of the sign 12 at an edge region by the sign holder 10. The stiff, durable material of the sign 12 resists damage to the sign 12, for example if the sign is bumped when a customer passes by, when struck by a shopping cart as it is moved along the aisle, or during restocking of the shelves with products by store personnel.

The sign 12 may be held by a single sign holder 10, as shown, or may be supported by two or more sign holders 10 engaged along an edge region of the sign 12. For example, a large sign may span two or more shelves and may be held by a first sign holder 10 mounted to an upper shelf 16 and engaged along the edge region closer to the top of the sign 12 and by a second sign holder 10 that is mounted to a lower shelf and engaged closer to the bottom of the sign. Other configurations and mounting locations are also possible and are within the scope of this invention.

The sign 12 may include indicia 18 announcing a sale, indicating a product location, promoting a new product or existing product, identifying a category of goods, or providing other information and/or one or more images. The sign 12 and sign holder 10 may be used in a product promotion, for example, where a product is promoted in one or several stores by signs mounted on shelves and other mounting locations within the store for a period of time, for example, for the duration of a promotional period. The signs 12 may be mounted in the store for the promotional period by store personnel or by a service.

The sign holder 10 is configured to grip the sign 12 by an edge region or, more specifically, by a border or edge portion 12a near an edge of the sign 12. The sign holder 10 has a body 20 with a high friction strip 22. The portion 12a of the sign 12 near the edge is pressed against the high friction strip 22 by a pressing portion 24. The pressing portion 24 is secured to the body 20 by a screw 26. The screw 26 is tightened to press the edge portion 12a of the sign 12 against the high friction strip 22. A Phillips head screw 26 is shown, although any type of screw may be provided. The sign 12 is gripped tightly to reduce the chance that the sign 12 may become dislodged when bumped. The sign holder 10 has a mounting portion 28 extending from the back by which the sign holder 10 is mounted to the under-shelf support 14. The sign holder 10 may be formed of injection molded plastic or other material. The high friction strip 22 may be formed of PVC, rubber, or other pliable, high friction material.

The under-shelf support or base 14 has a front mounting plate 30 to which the mounting portion 28 is connected. The front mounting plate 30 is connected to a lower arm 32 that extends from in front of the shelf 16 to underneath the shelf 16. A gusset 34 supports the front mounting plate 30 at a right angle to the front end of the lower arm 32. The opposite end of the lower arm 30 is connected by an extension 36 to the bottom of a magnet body 38. The magnet body 38 holds a magnet 40 and two steel plates 42 with the magnet 40 between the steel plates 42. The magnet 40, via the steel plates 42, magnetically attaches the under-shelf support 14 to the underside of the shelf 16. A wedge 44 or other extension (shown partially in phantom) extends from the magnet body 38 in a direction opposite the lower arm 32. A top surface 46 of the wedge 44 or other extension may be flush with or slightly spaced below the top edge of the steel plates 42. The top surface 46 of the wedge 44 or other extension may bear against the underside of the shelf 16 to prevent the front of the under-shelf support 14 from tipping downward due to the weight of the sign 12 and sign holder 10, particularly if a heavy sign 12 is used. By attaching the support 14 to the underside of the shelf 16, a top 48 of the shelf 16 is available to products without requiring space on the shelf 16 for the support 14. The under-shelf support 14 also avoids mounting the sign holder to the front edge of the shelf, which may already be occupied by price tags and other product information. The under-shelf support 14 may be formed of injection molded plastic into which the magnet 40 and steel plates 42 are mounted, although other materials are possible.

The shelf 16 may be any shelf or other structure on which the sign 12 is to be mounted. In the illustration, the shelf 16 is formed of steel, has the flat top surface 48 on which products may be displayed, and has a downwardly angled front 50 on which shelf labels, price tags, and the like may be located. The extension 36 on the magnet body 38 positions the lower arm 32 below the downwardly directed front 50 and the upwardly directed front mounting plate 30 positions the sign holder 10 at or above the level of the shelf 16. The sign holder 10 and under-shelf support or base 14 may be mounted to indicate products placed on top of the shelf 16 even when affixed under the shelf 16. The shelf 16 may have openings in it, such as the rows of openings 52 shown. The front 50 of the shelf 16 may have one or more channels 54 or other shapes.

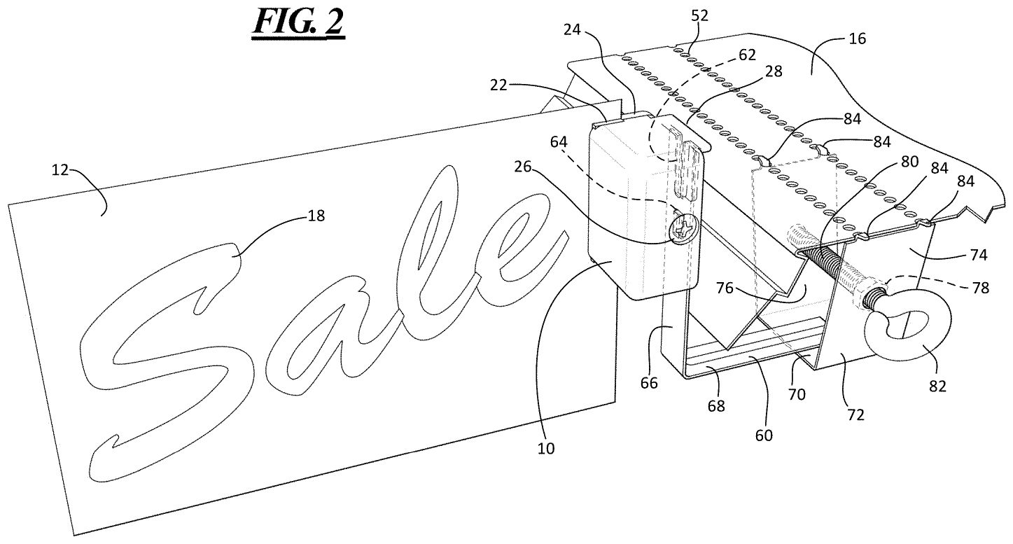

Turning to FIG. 2, the secure grip sign holder 10 is holding the sign 12 in front of the shelf 16 using an under-shelf support 60, which may also be referred to as a base 60. The secure grip sign holder 10 and base 60 hold the sign 12 in a position perpendicular the underside of the shelf 16 to which the base 60 is affixed. The sign holder 10 and base 60 also hold the sign 12 perpendicular to the longitudinal direction of the shelf 16.

The sign 12, which may have the indicia 18, is held by being pressed against the high friction strip 22 by the pressing portion 24 and is secured in place by tensioning the screw 26. The secure grip sign holder 10 may be the identical to the sign holder 10 shown in FIG. 1 or may be different. The secure grip sign holder 10 is mounted on the under-shelf support 60 by the mounting portion 28, which includes a T-shaped projection 62 and a catch nose 64, both of which are shown in phantom. The T-shaped projection 62 may have a T shape in two perpendicular planes, as will be described in conjunction with other figures.

The secure grip sign holder 10 is mounted on a front mounting plate 66 of the under-shelf support or base 60. The front mounting plate 66 is shaped to fit the mounting portion 28, such as by having a slot that receives the T-shaped projection 62 and an opening that receives the catch nose 64. The front mounting plate 66 extends vertically as a result of a right angle bend from a lower arm 68. The lower arm 68 may include a longitudinal crease or ridge for added rigidity. The lower arm 68 connects to a base 70 of a U bracket 72.

The U bracket 72 has two legs 74 and 76 extending from the base 70. The leg 74 includes an opening at which is affixed a threaded nut 78. A threaded bolt 80 extends through the nut 78 at the first leg 74 and bears against the second leg 76. The bolt 80 has a head 82 that may be grasped or otherwise operated to rotate the bolt 80. When the bolt 80 is positioned with its end away from the second leg 76, the legs 74 and 76 of the U bracket 70 may be flexed toward one another. Each leg 74 and 76 has two angled tabs 84 at its end. The angled tabs 84 are sized and arranged to fit into the openings 52 in the shelf 16. By flexing the legs 74 and 76 toward one another, the angled tabs 84 may be positioned in the openings 52 in the shelf. By rotating the bolt 80 so that the end of the bolt 80 presses against the second leg 76, the legs 74 and 76 are moved apart, which secures the angled tabs 84 in the openings 52. The angled tabs 84 are directed outwardly on the respective legs 74 and 76. The under-shelf support 60 is fastened to the underside of the shelf 16 by positioning the tabs 84 in the openings 52 and rotating the bolt 80 to push the legs 74 and 76 apart, engaging the tabs 84 in the openings 52.

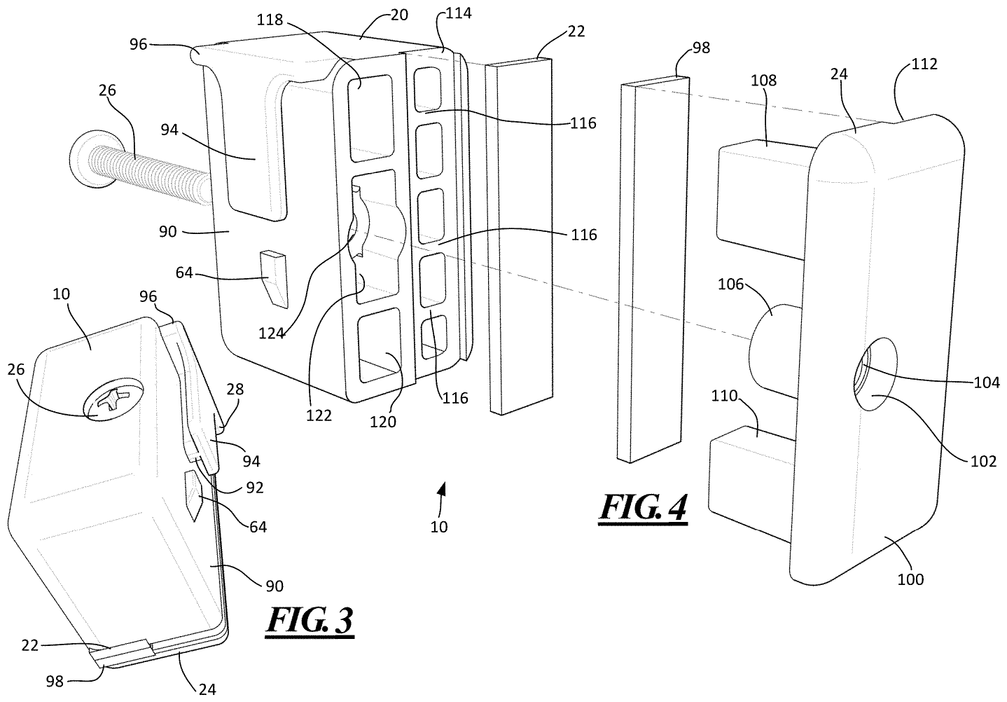

With reference to FIG. 3, the secure grip sign holder 10 has a generally rectangular shaped body with the mounting portion 28 on a back surface 90. The mounting portion has the T-shaped projection 62 extending away from the back surface 90. The T-shaped projection has an elongated wall 92 extending perpendicularly from the back surface 90. A parallel plate 94 is atop the wall 92 and parallel to the back surface 90. The T shape is seen when viewed in a direction parallel to the back surface from the lower end of the sign holder 10 toward the upper end of the sign holder 10. In this view, the elongated wall 92 forms the stem of the T and the parallel plate 94 forms the cross bar of the T. The front mounting plate 30 or 66 of the under-shelf support 14 or 60 extends between the parallel plate 94 and the back surface 90 when the sign holder 10 is mounted on the under-shelf support. A slot in the front mounting plate 30 or 66 receives the elongated wall 92. In other words, the elongated wall 92 fits into the slot in the front mounting plate 30 or 66.

The elongated wall 92 and the parallel plate 94 extend to an upper end of the secure grip sign holder 10. A stop wall 96 extends from the top of the top of the sign holder 10 in a direction perpendicular to the back surface. The parallel plate 94 and the stop wall 96 form a T shape when viewed in a direction toward the back surface 90 from the back of the sign holder 10, with the parallel plate 94 forming the stem of the T and the stop wall 96 forming the cross bar. Further, the elongated wall 92 and the stop wall 96 form a T shape when viewed in cross section taken through the elongated wall 92 and the stop wall 96 in a direction parallel to the back surface 90. The elongated wall 92 forms the stem of the T and the stop wall 96 forms the crossbar of the T.

The catch nose 64 extends from the back surface 90. The catch nose 64 is in line with the elongated wall 92 and has a ramp-shaped end directed toward the bottom of the sign holder 10. The ramp leads to a flat section. The top of the catch nose 64 has a perpendicular surface. The catch nose 64 is shaped to slide into a catch opening of the under-shelf support or base 14 or 60 and to engage in the catch opening to secure the sign holder on the under shelf support. The catch nose can be formed in other shapes. For example, a catch nose having a cylinder or button shape extending the back surface 90 is provided in an alternate embodiment.

The screw 26 is shown in a recess in the body 20 of the sign holder 10. The recess may be deeper so that the screw is less apparent to the casual observer. A cross-head screw 26 is provided in the illustrated embodiment. Other types of screws or fasteners may be used, for example, a slotted head screw, a hex head screw, a torx or star-head screw, spanner head screw, or type of screw may be provided. The screw type may be selected to reduce the chance of an unauthorized person having the corresponding tool for loosening the screw.

The pressing portion 24 has a high friction strip 98 of its own, positioned opposite to and pressing against the high friction strip of the body 20. In use, the sign 12 is positioned between the two high friction strips 22 and 98. The high friction strips 22 and 98 provide first and second gripping faces of the body 20 and pressing portion 24.

In FIG. 4, the secure grip sign holder 10 includes the pressing portion 24, the high friction strip 98, the high friction strip 22, the body 20, and the screw 26. The pressing portion 24 includes an end face 100 into which is formed a recess 102. Within the recess 102 is mounted a threaded nut 104 that receives the screw 26. Extending from the pressing portion 24 in a direction opposite the end face 100 is a cylinder 106 within which is mounted the threaded nut 104 and two rectangular guides 108 and 110. The surface of the pressing portion 24 opposite the end face 100 has a recess 112 into which the high friction strip 98 is received. The recess 112 and high friction strip 98 are near the front of the pressing portion 24, and the cylinder 106 and rectangular guides 108 and 110 are near the back of the pressing portion 24. The high friction strip 98 may be held in the recess 112 by adhesive.

The body 20 of the sign holder 10 has a recess 114 into which the high friction strip 22 fits. The high friction strip 22 may be held in the recess 114 by adhesive. The recess 114 and the high friction strip 22 are near the front of the body 20. Four parallel braces 116 extend from the inside of the front surface at the recess 114, strengthening the front portion of the body 20 and defining a series of holes behind the recess 112. The rear portion of the body 20 has two rectangular channels 118 and 120 into which the rectangular guides 106 and 108 fit. A center channel 122 is shaped to accept the cylinder 106 of the pressing portion 24. The cylinder 106, guides 108 and 110, and channels 118, 120 and 122 are shaped to allow the pressing portion 124 to slidably and translationally move relative to the body 20 during rotation of the screw 26. The guides 108 and 110 fitting into the channels 118 and 120 maintain the pressing portion 24 in an aligned position with the body 20 during movement. The cylinder 106 and guides 108 and 110 extend between the pressing portion 24 and the body 20 when the pressing portion 24 and body are spaced apart to accept a sign 12. The edge of the sign 12 may contact the cylinder 106 and guides 108 and 110, which may serve as alignment pins or alignment surfaces during insertion of the sign 12 and ensure a uniform insertion and position of the sign prior to tightening the screw 26.

The back surface 90 has the parallel plate 94 and stop wall 96 in a T shape. The catch nose 64 is below the parallel plate 94. The screw 26 is shown in position for insertion into a bore 124 for threadably engaging the nut in the cylinder 106.

In FIG. 5, the sign holder 10 is seen from the front. The screw 26 is received in the bore 124 in the body 20. The screw 26 has a head 130 that seats on a shoulder in the bore 124 to transfer the screw tension to the body 20 as the screw 26 is tightened. The bore 124 is not threaded and is configured so that the screw 26 may rotate within the bore 124. The screw 26 extends into the threaded nut in the cylinder 106 so that the pressing portion 24 is moved toward or away from the body 20 as the screw 26 is rotated. The body 20 has the recess 114 for the high friction strip 22 on the side facing the pressing member 24 and near a front surface 132 of the body 20. The stop wall 96 extends from the back surface opposite the front surface 132. The high friction strip 98 on the pressing portion 24 presses against one side of the sign 12 and the high friction strip 22 presses against the other side of the sign 12 as the screw 26 is tightened in the body. The threaded screw 26 provides a secure grip on the sign 12 regardless of the thickness of the sign 12, because the screw 26 is long enough to accommodate different thicknesses of signs 12.

The rectangular guides 108 and 110 are aligned with the cylinder 106 on the end of the pressing portion 24 facing the body 20 and near the back surface of the sign holder 10. Surfaces 134, 136 and 138 of the rectangular guides 108 and 110 and the cylinder 106 are generally co-planar to provide alignment surfaces for an edge of the sign 12. The sign 12 may be inserted until the edge of the sign 12 contacts one of the surfaces 134, 136 and 138 and then repositioned so that the edge of the sign is in contact with two of or all of the surfaces 134, 136 and 138. This may align the sign 12 in the sign holder 10, for example, so that multiple signs along an aisle are aligned and even. Other alignment surfaces may be provided, for example, depending on the shape of the sign 12. For example, it is contemplated to provide one or more alignment projections or other structure in the sign holder 10 to engage into corresponding notches in the sign 12 or another structure of the sign to provide a uniform positioning of the sign in the sign holder 10.

The recess 112 for receiving the high friction strip 98 may have reinforcing braces 140 behind the recess 112 for added strength. The high friction strips 22 and 98 are shown as having a smooth surface at a gripping surface 142 that engages the sign 12. The gripping surfaces 142 may be provided with ribs, projections, bumps, channels or other shapes or textures as desired.

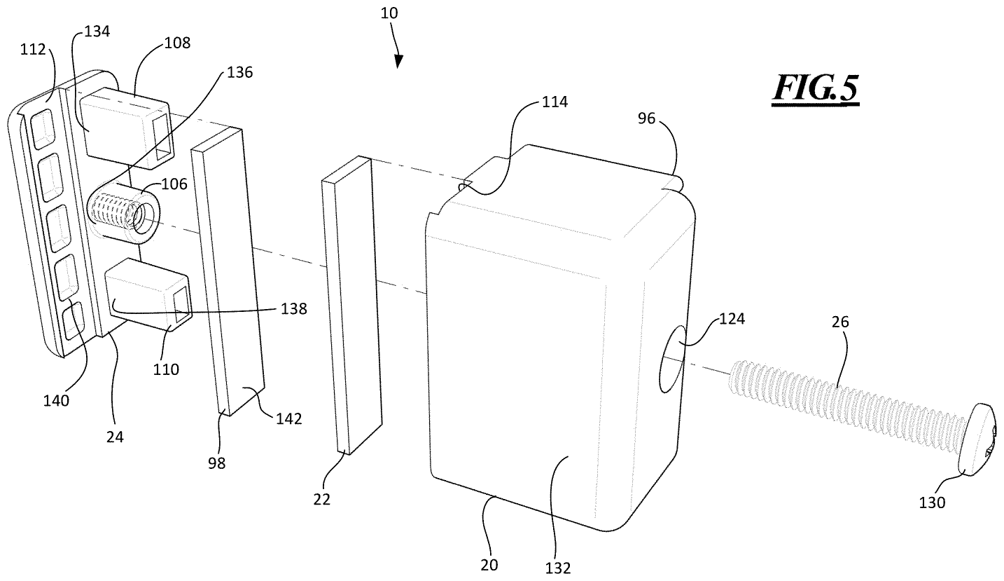

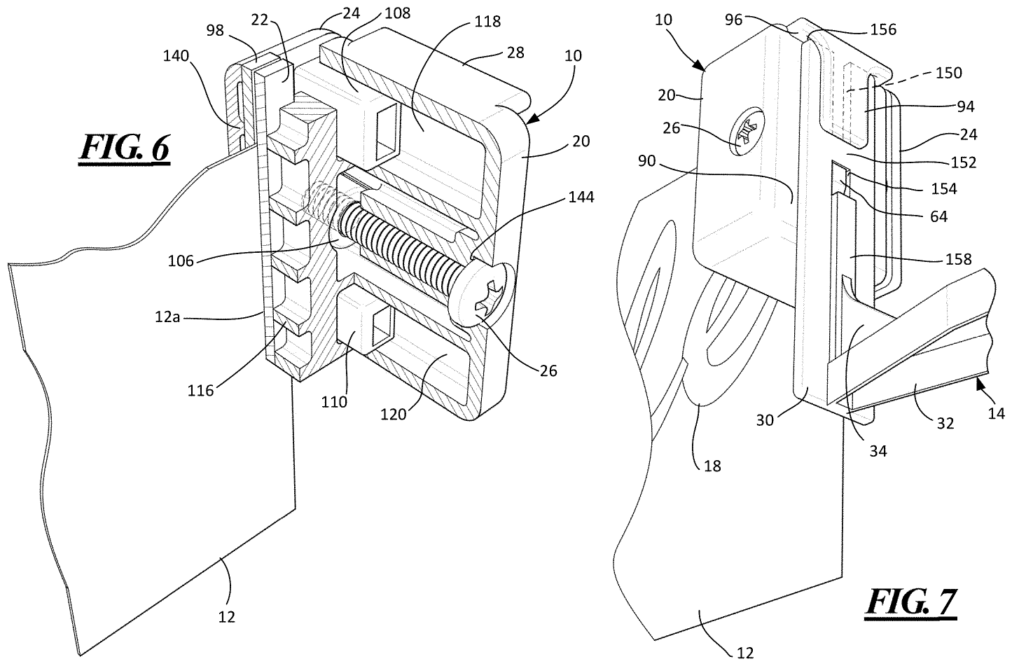

With reference to FIG. 6, the sign 12 is gripped between the high friction strips 22 and 98 at the edge portion 12a. The reinforcing braces 140 and 116 provide support for the backs of the high friction strips 22 and 98, ensuring distribution of the gripping force along the length of the high friction strips 22 and 98. The gripping force on the high friction strips 22 and 98 is provided by the screw 26 exerting tension between a shoulder 144 within the bore and the threaded nut within the cylinder 106 as the screw 26 is tightened. Movement of the pressing portion 24 toward and away from the body 20 is permitted by the rectangular guides 108 and 110 moving within the rectangular channels 118 and 120. The sign 12 may be removed and replaced by a different sign by loosening the screw 26 so that the high friction strips 22 and 98 release their grip on the sign 12. Thicker or thinner signs 12 may be held in the sign holder 10.

In FIG. 7, the sign holder 10 is mounted on the front mounting plate 30 of the under-shelf support or base 14. The front plate 30 has a generally planar shape and defines a slot 150 that extends vertically in the front plate and is open to the top edge. The elongated wall 92 of the sign holder 10 fits into the slot 150. The front plate 30 is of a thickness that fits between the parallel plate 94 and the back surface 90. The slot 150 may be long enough to accommodate the full length of the elongated wall 92, which may result in the top edge of the front plate 30 contacting the stop wall 96 at the top of the sign holder 10 when the sign holder 10 is mounted on the front plate 30.

Below the slot 150 is a transverse portion 152 and below the transverse portion is an opening 154 for receiving the catch nose on the sign holder 10. As shown, the catch nose 64 fits into the opening 154, which secures the sign holder 10 to the front plate 30. To mount the sign holder 10 on the front plate 30, the catch nose 64 and the elongated wall 92 are aligned with the slot 150. The sign holder 10 and front plate 30 are moved relative to one another to slide the catch nose 64 and the elongated wall along the slot 150. As the catch nose 64 reaches the bottom of the slot 150 at the transverse portion 152, the tapered or sloped bottom edge of the catch nose 64 permits the catch nose 64 to slide over the transverse portion 152 until the catch nose 64 reaches the opening 154, whereupon the catch nose 64 engages into the opening 154. The catch nose 64 is urged into the opening 154 as a result of the front plate 30 being maintained generally against the back surface 90 by the parallel plate 94.

Once the catch nose 64 is in the opening 154, the top edge of the catch nose 64 abuts a top edge of the opening 154. The catch nose 64 has a top edge surface that is perpendicular to the back surface 90. The opening 154 has a top edge surface that is also perpendicular to the back surface 90. These perpendicular walls abut one another to prevent the catch nose 64 from being moved out of the opening 154 and sliding back over the transverse portion 152 without particular effort. Once in position on the front plate 30, the sign holder 10 is maintained in the mounted position. In certain embodiments, a top 156 of the front plate 30 abuts or nearly abuts the stop plate 96 when the catch nose 64 is in the opening 154. By configuring the mounting components in this way, little to no movement between the sign holder 10 and the front under-shelf support 14 is possible, reducing the chance of unwanted removal of the sign holder 10 from the under-shelf support 14.

The front plate 30 has a reinforcing rib 158 extending from the opening 154 to the gusset 34. The gusset 34 maintains the front plate 30 at a right angle, or other desired angle, to the lower arm 32. The sign 12, which is held securely in the sign holder between the high friction strips 22 and 98 under the force of the screw 26, may be changed by loosening the screw 26 while the sign holder 10 is mounted on the front plate 30 of the under-shelf support or base 14.

In FIG. 8 is shown a suction cup adapter or base 160 for mounting the secure grip sign holder 10 to a glass panel or other smooth surface 162. The smooth surface 162 may be, for example, a glass door of a frozen food cooler or chilled beverage cooler such as may be provided in a grocery store, convenience store, restaurant, gas station, bait shop, pet store, or other facility. The smooth surface 162 may be a window, door, wall, panel, cabinet, case, post, or other surface of glass, metal, plastic, wood, tile, enamel, paint, varnish, or other material.

The secure grip sign holder 10 is shown holding a sign 12 in a position where it may be viewed by customers or other users of the facility. The sign 12 may be held in a position extending perpendicular to the smooth surface 162. In particular, the sign 12 is held in a position perpendicular to the smooth surface 162 to which the base 160 is mounted. The secure grip sign holder 10 is of the same or similar construction as shown in the preceding figures and is mounted on a front surface of the suction cup adapter 160. The suction cup adapter 160 is generally planar and of a triangular shape having rounded corners. The illustrated embodiment includes three suction cups 164 mounted to the suction cup adapter 160. The suction cups 164 each have a button 166 on the front side of the suction cup adapter 160, a neck or shaft 168 connected to the button 166 that extends through respective openings in the suction cup adapter 160, and a cup portion 170 at a back side of the suction cup adapter 160. The cup portion 170 is flexible to flatten as it is pressed against the smooth surface 162 so as to create space of low pressure or partial vacuum between the cup portion 170 and the smooth surface 162. The outer edge of the cup portion 170 presses against the smooth surface 162 to prevent air from entering the low pressure space, holding the suction cup 164 to the smooth surface 162. A release tab 172 extends from the outer edge of the cup portion 170. The release tab 172 may be grasped or otherwise engaged to lift a part of the outer edge of the cup portion 170 away from smooth surface 162, permitting air to enter the low pressure space and releasing the engagement of the suction cup 164 from the surface.

In FIG. 8, the release tab 172 is maintained in a position where it may be accessed by a user for release of the suction cup 164. The suction cup adapter 160 extends from the neck or shaft 168 of the suction cup 164 to the outer edge of the cup portion 170 to cover and enclose the cup portion 170. The release tab 172 extends beyond the edge of the suction cup adapter 160 so that a user may engage the release tab 172. The suction cup adapter 160 has rounded corners of a curvature corresponding to the radius of the cup portion 170 of the suction cup 164. Only the release tab 172 extends from behind the suction cup adapter 160, for instance, when viewed from the front.

The release tab 172 extends in a horizontal direction toward the right from the upper right suction cup 164. An upper left suction cup 164a is mounted in the suction cup adapter 160 so that its release tab 172a extends in a horizontal direction to the left. A lower center suction cup 164b is mounted in the suction cup adapter 160 so that its release tab 172b extends vertically downward. Each of the release tabs 172, 172a and 172b extend from behind the suction cup adapter 160 and may be engaged by a user to release each suction cup 164, 164a and 164b from the smooth surface 162.

In an alternative embodiment, one or more of the release tabs 172, 172a. and 172b may be positioned behind the suction cup adapter 160, for example, to prevent release of the suction cups 164 by unauthorized persons. The suction cups 164 may be mounted with the release tabs 172 behind the suction cup adapter 160. For example, the suction cups may be mounted in a rotated position relative to the illustration in FIG. 8 with the release tabs 172 under the adapter 160 rather than extending from the edge thereof. Suction cups without release tabs may be provided instead.

The size of the suction cups 164 are matched to the radius of the corners of the adapter 160 in the illustration. It is foreseeable that the suction cups 164 may be of a larger or smaller size than the corner radius of the suction cup adapter 160.

The neck or shaft 168 of the suction cups are of a square or rectangular shape in the illustrated embodiment. The openings in which the suction cups 164 are mounted are of a square or rectangular shape. The square neck or shaft 168 in the square opening prevents the suction cup 164 from rotating in the suction cup adapter 160. The release tab 172 is positioned in the desired orientation and is maintained in the desired orientation as a result of the square neck fitting into the square hole. Other shapes of the suction cup neck or shaft are also possible as are other shapes of the hole in which the suction cup is mounted.

The suction cups 164 may be mounted in the suction cup adapter 162 by inserting the buttons 168 through the openings in the suction cup adapter 160. The suction cups 164 are oriented with the release tab 172 extending from the desired side of the suction cup adapter 160. Other mounting methods may be provided.

With reference to FIG. 9, the suction cup adapter 160 is of a triangular shape with a flat front surface 180 at the periphery of which is provided a beveled edge 182. The beveled edge 182 is rounded in a convex shape and curves away from the flat front surface 180 toward the surface to which the adapter is affixed. Three openings 184 are provided for receiving the neck or shaft 168 of a respective suction cup 164. The openings 184 are square or rectangular to receive the square or rectangular neck or shaft of the respective suction cup. The respective openings 184 are adjacent the three corners of the triangular suction cup adapter 160 and are set back from the corners by a radius of the cup portion 170 of the suction cups 164. A raised projection 186 extends around each of the openings 184. Each raised projection 186 is circular in shape and corresponds generally to the size and shape of the buttons 166 of the suction cups 164. The raised projections 186 extend out from the flat front surface 180 and are flat at their forward projecting portion, having a flat front surface that is parallel to the flat front surface 180 of the suction cup adapter 160. The raised projections 186 each include a cylindrical perimeter wall that is connected to the flat front surface 180 by a beveled portion 188. The beveled portion 188, which is wider at the flat front surface 180 and tapers inward at the cylindrical wall 86, has a concave shape or inward curve when viewed in cross section along the axis of the cylindrical wall 186. The raised projections 186 extend by a first distance from the flat front surface 180.

A front mounting plate 190 extends from the flat front surface 180. The front mounting plate 188 has a front portion with a T-shaped slot 192 and a lock opening 194. The T-shaped slot 192 is configured to receive the elongated wall 92 of the mounting portion 28. The lock opening 194 is configured to receive the catch nose 64. The front portion of the front mounting plate 190 is raised by a second distance from the flat front surface 180. In certain embodiments, the second distance of the front mounting plate 190 is greater than the first distance of the raised projections 186 from the flat front surface 180.

In the back view of FIG. 10, the suction cup adapter 160 has a planar back surface 200 of a generally triangular shape with rounded corners. The beveled edge 182 that curves in a rearward direction from the flat front surface 180 forms a perimeter wall 202 that extends in a rearward direction around the planar back surface 196. The perimeter wall 202 extends to near or even against the surface 162 to which the suction cup adapter 160 is affixed. A space 204 is defined between the suction cup adapter 160 and the surface 162 and is partially or completely closed by the perimeter wall 202. The suction cups 164 are within the space 204 when the suction cup adapter 160 is affixed to the surface 162. In some embodiments, the perimeter wall 202 may be in contact with or be very close to the surface 162. The visual effect is that the body of the suction cup adapter 160 is connected to or is disposed very close to the surface 162. The suction cups 164 may not be readily visible to the casual observer when the suction cup adapter 160 is mounted to the surface 162 as a result of being enclosed within the space 204 by the perimeter wall 202.

The raised projections 186 that extend from the front surface 180 around the openings 184 are the result of circular recesses 206 that extend into the planar back surface 200 of the suction cup adapter 160. The circular recesses 206 are located at the openings 184 and are shaped to accommodate a center part of the cup portion of the suction cups 164. The center part of the cup portion of each suction cup 164 fits into the respective circular recesses 206 so that only the outer parts of the cup portion of the suction cup 164 extends from the planar back surface 200. The result is that the suction cups 164 extend a shorter distance from the planar back surface 200 than if the center of the cup portion were mounted at the plane of the planar back surface 200. The circular recesses 206 have a beveled outer portion 208 to accommodate flexing of the cup portions of the suction cups 164 when the suction cup 164 flexes between an uncompressed state and a compressed stated that is adhered to a surface. The center of the cup portions are fitted into the circular recesses 206 to provide a low profile of the suction cup adapter 160 on the surface 162.

The front mounting plate 190 that extends from the front of the suction cup adapter 160 when viewed from the back includes a rectangular recess 210 that extends into the planar back surface 196. Within the rectangular recess 210 is the front mounting plate 190 with the T-shaped slot 192 and the lock opening 194. The T-shaped projection 62 of the secure grip sign holder 10 may be slid into position within the rectangular recess 210 to secure the holder 10 onto the suction cup adapter 160.

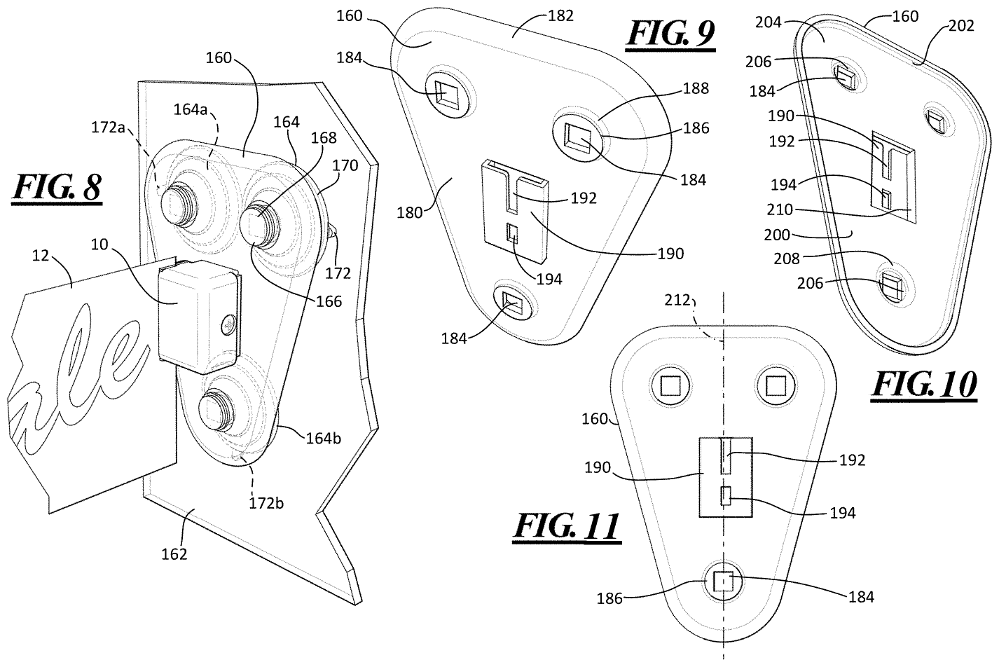

In FIG. 11, an imaginary line 212 is shown extending vertically along the center of the triangular-shaped suction cup adapter 160. The secure grip sign holder 10 that may be mounted onto the suction cup adapter 160 to hold a sign 12 is configured to hold the sign at the left side of the secure grip sign holder 10. The front mounting plate 190 is positioned with its center shifted to the right of the center line of the suction cup adapter 160. The offset of the front mounting plate 190 to the right compensates to at least some of the offset to the left of the sign 12 in the secure grip sign holder 10. The offset of the front mounting plate 190 may be greater or less, as desired. For instance, a greater offset may be provided where a larger sign is to be held, and a lesser offset for holding smaller signs.

It is envisioned that the secure grip sign holder may be configured to hold signs at the right side. In one example, the sign holder may be a mirror image of the illustrated sign holder. The suction cup adapter for such sign holders may be configured to offset the front mounting plate to the left.

Thus, there is shown and described a sign holder that grips a sign by pressing gripper jaws against opposite sides of the sign at an edge region of the sign. The sign holder includes a fastener to exert a pressing force on the gripper jaws. A mounting portion on the sign holder mounts onto a front plate of a base. The base may include an under-shelf support configured to attach to an under-side of a shelf, either by a magnet or a clamp. The base may include a plurality of suction cups mounted on a suction cup adapter to which the sign holder may be affixed.

Although other modifications and changes may be suggested by those skilled in the art, it is the intention of the inventors to embody within the patent warranted hereon all changes and modifications as reasonably and properly come within the scope of their contribution to the art.

1. A sign holder for holding a sign, comprising:
a body having a first gripping face and a mounting portion,
the mounting portion having a T-shape configured for mounting to a base, the mounting portion including:
a first surface and a second surface defining a space between the first and second surfaces,
an elongated wall extending between the first and second surfaces, the elongated wall being elongated in a first direction,
a stop wall extending transverse to the elongated wall at an end of the space between the first and second surfaces, and
a catch nose extending from the first surface, the catch nose being configured to engage a recess of the base to secure the mounting portion to the base, wherein the catch nose includes a tapered edge configured to slidably engage the base such that the mounting portion slides up the tapered edge and onto the catch nose as the mounting portion and the base are moved relative to one another to an engagement of the catch nose and the recess;
a pressing portion having a second gripping face disposed opposite the first gripping face; and
a fastener securing the body and the pressing portion together in a gripping position, the first and second gripping faces being configured for gripping a sign between the first and second gripping faces when in the gripping position.

2. The sign holder as claimed in claim 1, wherein one of the body and pressing portion includes an extension and the other of the body and pressing portion includes a channel configured to receive the extension, the extension extending into the channel when the body and pressing portion are in the gripping position.

3. The sign holder as claimed in claim 2, wherein the extension includes two extensions and the channel includes two channels into which respective ones of the two extensions extend when in the gripping position, the two extensions include alignment surfaces configured for aligning an edge of a sign held between the first and second gripping faces.

4. The sign holder as claimed in claim 2, wherein the body has a front surface and a back surface, wherein the mounting portion is at the back surface of the body, wherein the channel for receiving the extension is adjacent the back surface of the body, wherein the body defines a recess for receiving a high friction strip adjacent the front surface, and further comprising: a high friction strip mounted in the recess in the body.

5. The sign holder as claimed in claim 4, wherein the high friction strip is a first high friction strip, wherein the pressing portion defines a recess for receiving a second high friction strip, and further comprising: a second high friction strip mounted in the recess in the pressing portion, the first and second high friction strips being opposite one another on facing ends of the body and the pressing portion and being configured for engagement on opposite sides of a sign.

6. The sign holder as claimed in claim 1, wherein the fastener includes a screw.

7. The sign holder as claimed in claim 6, wherein the pressing portion includes a threaded nut configured to receive the screw, wherein the body defines a bore through which the screw extends when the body and the pressing portion are in the gripping position and when the screw is threaded into the nut in the pressing portion, the body and pressing portion being configured to exert a gripping force on the gripping portions when the screw is tightened in the bore.

8. The sign holder as claimed in claim 1, wherein the body has a back surface, wherein the T-shaped mounting portion is provided by a T-shaped projection extending from the back surface.

9. The sign holder as claimed in claim 1, further comprising:
the base that is configured for connection to the mounting portion of the body, the base being configured for mounting to a structure so that the sign held in the sign holder extends perpendicular to the structure, the base including a mounting plate having first and second portions configured to fit into the space between the first and second surfaces of the mounting portion, the first and second portions defining a slot between the first and second portions configured to receive the elongated wall, the first and second portions having ends configured to abut the stop wall when the first and second portions are in the space.

10. The sign holder as claimed in claim 9, wherein the base includes an under-shelf attachment portion configured for mounting to an underside of a shelf, the base being configured for holding the sign at a front of the shelf and perpendicular to the shelf.

11. The sign holder as claimed in claim 10, wherein the under-shelf attachment portion includes one of:
a magnet configured to magnetically engage an underside surface of a shelf, or
a plurality of tabs configured to engage into holes on an underside of a shelf, and further comprising:
a projecting portion extending from the under-shelf attachment portion to a receiving portion configured for receiving the mounting portion of the body.

12. The sign holder as claimed in claim 11, wherein the receiving portion includes a planar member having a slot and the recess, wherein the elongated wall of the mounting portion is configured for engagement with the slot.

13. The sign holder as claimed in claim 1, further comprising the base that is configured for connection to the mounting portion of the body, wherein the base includes a suction cup adapter and a plurality of suction cups mounted in the suction cup adapter, the suction cup adapter including a front mounting plate on which is mounted the mounting portion of the body, the base being configured to hold the sign perpendicular to a surface to which the suction cups are affixed when the suction cups are affixed to the surface, the front mounting plate including first and second portions defining a slot between the first and second portions, the first and second portions being configured to fit into the space between the first and second surfaces with the elongated wall extending into the slot, the first and second portions being configured to abut the stop wall when the mounting portion is mounted on the front mounting plate.

14. The sign holder as claimed in claim 13, wherein the base includes a perimeter wall extending toward a surface when the suction cups are affixed to the surface, the perimeter wall enclosing a space between the base and the surface.

15. The sign holder as claimed in claim 14, wherein the suction cups each include a rectangular neck; wherein the base defines a plurality of rectangular openings in which the rectangular necks of the respective suction cups are mounted; and further comprising:
a release tab extending from an edge of each suction cup, the release tabs extending from the enclosed space below a lower edge of the perimeter wall, the release tabs being maintained in position extending from the enclosed space by the rectangular necks in the rectangular openings.

16. A method for mounting a sign, comprising:
affixing a base to a surface;
affixing a secure grip sign holder to a mounting portion of the base by sliding a T-shaped projection of the secure grip sign holder into a slot on the mounting portion of the base to engage a catch nose projecting from the secure grip sign holder with a recess of the mounting portion to secure the secure grip sign holder to the mounting portion, the mounting portion of the base fitting into a space between first and second surfaces of the secure grip sign holder, wherein the catch nose includes a tapered edge configured to slidably engage the mounting portion such that mounting portion slides up the tapered edge and onto the catch nose;
inserting an edge region of the sign between a body of the secure grip sign holder and a pressing portion of the secure grip sign holder; and
operating a fastener to slide guides of the pressing portion along channels in the body so as to move the pressing portion toward the body to engage the edge region of the sign between the pressing portion and the body, the sign being engaged at the edge region to extend perpendicular to the surface to which the base is affixed.

17. The method as claimed in claim 16, wherein the affixing the base to the surface includes affixing the base to an underside of a shelf so that the mounting portion extends from below the shelf to a position in front of a front edge of the shelf.

18. The method as claimed in claim 16, wherein the affixing the base to the surface includes securing a plurality of suction cups to the surface, the suction cups being mounted in the base.

19. The method as claimed in claim 18, further comprising:
enclosing the plurality of suction cups within a space between the base and the surface, the space being enclosed by a perimeter wall extending from the base toward the surface.

20. The method as claimed in claim 19, further comprising:
releasing the suction cups from the surface by engaging release tabs of the suction cups that extend from the space beneath the perimeter wall.

21. The sign holder as claimed in claim 1, wherein the body has a back surface, the back surface of the body providing the first surface of the mounting portion;
wherein the mounting portion having the T-shape includes a T-shaped projection from the back surface; and further comprising:
a parallel plate in parallel to the back surface of the body, the parallel plate providing the second surface of the mounting portion; and
wherein the elongated wall provides a stem of the T-shaped projection and the parallel plate provides a cross-bar of the T-shaped projection.

22. The sign holder as claimed in claim 1, wherein the body has a back surface providing the first surface of the mounting portion;
wherein the mounting portion having the T-shape includes a T-shaped projection from the back surface; and further comprising:
a parallel plate in parallel to the back surface of the body, the parallel plate providing the second surface of the mounting portion; and
wherein the parallel plate provides a stem of the T-shaped projection and the stop wall provides a cross-bar of the T-shaped projection.

23. The sign holder as claimed in claim 1, wherein the body has a back surface providing the first surface of the mounting portion;
wherein the elongated wall and the stop wall extend from the back surface of the body, the elongated wall providing a stem of the T-shaped mounting portion and the stop wall providing a cross-bar of the T-shaped mounting portion.

24. The sign holder as claimed in claim 1, wherein the body has a back surface providing the first surface of the mounting portion;
wherein the elongated wall and the stop wall extend from the back surface;
wherein the T-shaped mounting portion has a first T-shape including the elongated wall providing a stem of the first T-shape and the stop wall providing a cross-bar of the first T-shape;
wherein the T-shaped mounting portion has a second T-shape including a parallel plate in parallel to the back surface as the second surface of the mounting portion, the elongated wall providing a stem of the second T-shape and the parallel plate providing a cross-bar of the second T-shape; and
wherein the T-shaped mounting portion has a third T-shape including the parallel plate providing a stem of the third T-shape and the stop wall providing a cross-bar of the third T-shape.
